(19) United States
(12) Patent Application Publication
(10) Pub. No.: US 2026/0316947 A1
(43) Pub. Date: Oct. 15, 2026

(54) AUTOTHROTTLE CONTROL FOR HYBRID ELECTRIC TURBOPROP AIRCRAFT

(71) Applicant: GENERAL ELECTRIC COMPANY, Evendale, OH (US)

(72) Inventors: Arthur W. Sibbach, Boxford, MA (US); Brandon W. Miller, Middletown, OH (US); Erich Alois Krammer, West Chester, OH (US)

(21) Appl. No.: 19/179,440

(22) Filed: Apr. 15, 2025

(51) Int. Cl. B64D 31/18; B64C 11/30; B64D 31/08; B64D 31/09

(52) U.S. Cl. CPC B64D 31/18; B64C 11/30; B64D 31/08; B64D 31/09

(57) ABSTRACT

An autothrottle control system for a hybrid electric aircraft includes a throttle lever, a propulsion system comprising a turbomachine, an electric machine, and a propulsor, and an autothrottle controller operatively coupled to the propulsion system and the throttle lever. The autothrottle controller is configured to receive propulsion system data and throttle input, analyze the inputs to evaluate aircraft operating conditions, and determine a power mode for propulsion. Based on this analysis, the controller selectively adjusts one or more operational parameters, including fuel flow, electric power output, and propulsor pitch angle, to provide mechanical and/or electrical thrust in a targeted allocation that meets the thrust requirement while improving energy efficiency.

### TECHNICAL FIELD

The present disclosure relates to providing thrust control. Particularly, the present disclosure relates to autothrottle control for hybrid electric turboprop aircraft.

### BACKGROUND

An autothrottle controller can obtain speed or thrust measurements from the engine compared to a selected speed or thrust, and adjust engine power accordingly.

### BRIEF DESCRIPTION OF THE DRAWINGS

Illustrative aspects can take form in various components and arrangements of components. Illustrative aspects are shown in the accompanying drawings, throughout which like reference numerals can indicate corresponding or similar parts in the various drawings. The drawings are only for purposes of illustrating the aspects and are not to be construed as limiting the disclosure. Given the following enabling description of the drawings, the novel aspects of the present disclosure should become evident to a person of ordinary skill in the relevant art(s).

FIG. 1 illustrates an example autothrottle control for hybrid electric aircraft system, in accordance with an exemplary aspect;

FIG. 2 is a schematic diagram of an example implementation of the autothrottle control for hybrid electric aircraft system in a single engine aircraft, in accordance with an exemplary aspect;

FIG. 3 is a schematic diagram of an example implementation of the autothrottle control for hybrid electric aircraft system in a multiengine aircraft, in accordance with an exemplary aspect;

FIG. 4 is a flow diagram of an example method of autothrottle control for hybrid electric aircraft system, in accordance with an exemplary aspect; and

FIG. 5 illustrates a computing device in accordance with an exemplary aspect.

### DETAILED DESCRIPTION

Prior to discussing the drawings of the present disclosure at length, several terms and concepts are covered in order to facilitate the detailed description of the exemplary aspects depicted in the drawings. It is noted that however that these terms and concepts do not limit the disclosure and that one of ordinary skill in the relevant art(s) will readily recognize modifications and changes applicable to the following ancillary systems and/or concepts that do not limit the scope of the present teachings.

The present system addresses limitations of conventional autothrottle implementations by enabling intelligent, real-time control of hybrid propulsion systems using both a turbomachine and an electric machine. As used herein, an ‘electric machine’ refers to a component of the propulsion system that is operable as an electric motor, a generator, or both. The electric machine is configured to provide mechanical torque to a propulsor by converting electrical energy from onboard storage or generation systems, or to recover electrical energy during regenerative operation. The electric machine can include associated electronics such as inverters, motor controllers, and drive systems. As used herein, a ‘turbomachine’ refers to an engine that converts thermal energy from fuel combustion into mechanical energy to drive a propulsor, such as a propeller or fan. In various aspects of the present disclosure, the turbomachine is a gas turbine engine, such as a turboprop or turbofan, and can include components such as a compressor, combustor, turbine, and shaft for delivering rotational power.

Unlike traditional autothrottle systems designed for single-source propulsion, this system provides coordinated thrust control across multiple energy sources, optimizing fuel usage, electrical energy consumption, and overall performance based on real-time aircraft conditions. The autothrottle controller described herein supports hybrid thrust allocation, failure compensation, energy reserve management, and seamless operation with both legacy multi-lever and modern single-lever cockpit configurations to provide a technically distinct solution for hybrid electric turboprop aircraft.

The autothrottle controller system described herein addresses the technical problem associated with conventional autothrottle systems, which are typically designed for single-source propulsion and are not configured to manage multiple power sources in hybrid electric aircraft. In conventional systems, dynamically allocating thrust is challenging, and not achievable to allocate among a turbomachine and an electric machine based on real-time operational conditions. The disclosed autothrottle control system provides a technological improvement by enabling coordinated control of both fuel-based and electric propulsion sources, which enables improved energy usage, reduced fuel consumption, increased operational flexibility, and the ability to maintain propulsion in the event of partial system failure. The system further supports both single and multi-throttle configurations, enabling integration with legacy aircraft designs or future single-lever cockpit architectures.

As used herein, a “propulsion system” is a subsystem of the autothrottle controller system, which includes a turbomachine, an electric machine, and a propulsor (e.g., a propellor, a fan, or other rotating aerodynamic device configured to generate thrust) configured to provide propulsion using fuel-based, electric, or hybrid mechanical power.

In various aspects of the present disclosure, the autothrottle control system manages hybrid thrust delivery by adjusting turbomachine throttle position, electric machine output, and propeller pitch to meet a selected thrust or airspeed. The system compares speed or thrust measurements from the propulsion system with pilot or system-defined targets and dynamically allocates power among available sources.

The autothrottle controller can receive energy from multiple sources, including turbomachine fuel and electrical energy provided by fuel cells, solar panels, or batteries. Battery charging can occur via an electrical generator powered by the turbomachine, preferably during efficient engine operation to reduce parasitic losses.

In various aspects of the present disclosure, the autothrottle controller can respond to system demands by coordinating output from both fuel-based and electric power sources. Throttle positions and power settings are adjusted to optimize energy usage while satisfying total thrust requirements. Control actions can be based on pilot inputs or autonomous system commands.

The autothrottle controller can also respond to failures within the propulsion system. For example, in the event of a turbomachine or propulsor failure, the controller can increase electric machine output to maintain thrust. Such reallocation is dynamically adjusted based on real-time aircraft conditions, including speed, altitude, and ambient environment.

The system supports sourcing electrical energy from onboard storage elements, such as batteries, fuel cells, solar panels, or auxiliary power units (APUs). Batteries can be charged by a generator coupled to the gas turbine engine, with power extraction prioritized during periods of optimal engine efficiency.

In various aspects of the present disclosure, the autothrottle controller governs whether propulsion is provided by the turbomachine, electric machine, or both. The controller dynamically selects the propulsion mode depending on flight phase, energy reserves, and performance requirements. The propulsor can be a propeller or fan.

The autothrottle system is adaptable to various aircraft architectures. In single-lever configurations, the pilot provides a unified input for both engine power and propeller pitch. In multi-lever setups, separate controls can govern the turbomachine, electric machine, and propulsor pitch, enabling compatibility with legacy and advanced cockpit layouts.

Optimization objectives can include reducing emissions, minimizing contrail formation, conserving fuel, managing power system thermal loads, and maintaining minimum energy reserves. The system dynamically manages throttle settings to meet these goals across various mission profiles.

The controller can operate cooperatively with other engines in a multi-propulsor configuration, including APUs or distributed propulsion units. The controller can synchronize or decouple engine control based on thrust demands, power availability, or energy efficiency considerations.

Energy usage optimization can take into account multiple constraints, such as propulsion system health, ambient conditions, and mission phase. For example, electric machine operation is curtailed to prevent overheating, or fuel consumption is prioritized during battery depletion.

The system can integrate multivariate efficiency models for each thrust-producing component. Inputs to these models can include throttle position, ambient pressure, aircraft altitude, and air speed, and outputs can represent thrust-to-energy ratios or other performance metrics used to guide control decisions.

In multi-propulsor aircraft, the autothrottle system can adjust each engine's output independently or coordinate them through a unified command. This flexibility allows for asymmetric thrust handling, redundancy during engine degradation, or optimized energy distribution based on available reserves.

These adaptive behaviors allow the autothrottle system to enhance flight safety, operational flexibility, and energy efficiency, particularly in missions that require varying thrust demands, such as takeoff, cruise, loiter, or emergency descent profiles.

In various aspects of the present disclosure, thrust control is performed using one or more engine parameters, including N1 speed, torque output, or exhaust gas temperature (EGT). As used herein, “N1 speed” refers to the rotational speed of the engine's low-pressure spool, including the low-pressure compressor and turbine. N1 speed is typically expressed as a percentage of maximum revolutions per minute (RPM) and is used as a primary control parameter for regulating engine thrust. Torque output can represent the rotational force generated at the shaft and can be used as a proxy for thrust when driving a propulsor. EGT is monitored to ensure thermal limits are not exceeded and can also indicate changes in engine performance or efficiency, which influence how much thrust can safely be commanded under current operating conditions.

In various aspects of the present disclosure, thrust is adjusted to maintain a constant airspeed.

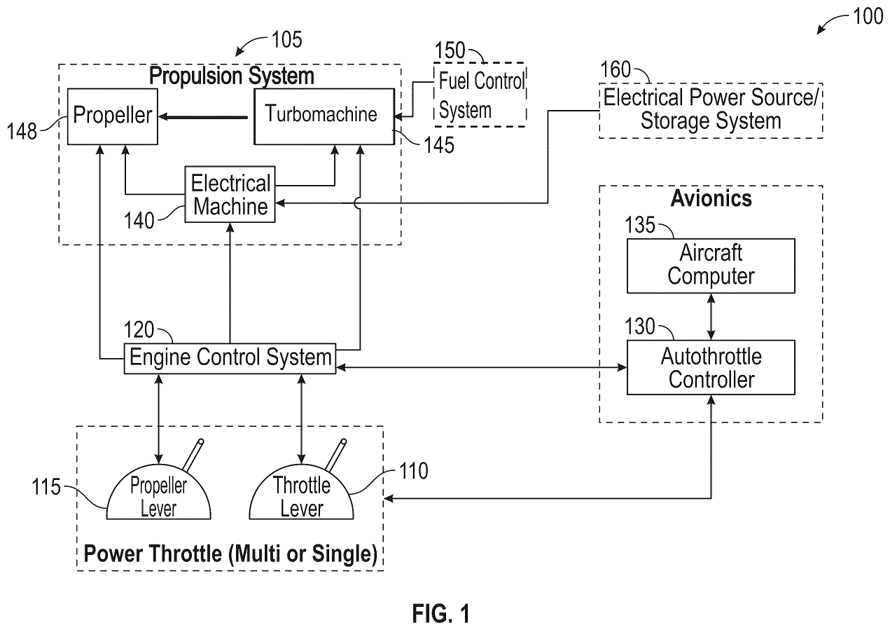

FIG. 1 illustrates an example autothrottle control for hybrid electric aircraft system 100, in accordance with an exemplary aspect. The hybrid electric aircraft system 100 includes a propulsion system 105, a throttle lever 110, a propulsor 146, and a propulsor lever 115. In some aspects of the present disclosure, throttle lever 110 and propulsor lever 115 can collectively be a power throttle for a multi or single engine aircraft. The throttle lever 110 can control thrust to the propulsion system 105, and the propulsor lever 115 can control the pitch of blades on the propulsor 146. In various aspects of the present disclosure, a single throttle lever 110 can control power/speed and propulsor pitch angle.

The hybrid electric aircraft system 100 also includes an engine control system 120, an autothrottle controller 130, an aircraft computer 135, a fuel control system 150, and an electrical power source/storage system 160.

The propulsion system 105 is a hybrid propulsion system, which includes an electric machine 140, a turbomachine 145, and the propulsor 146. The propulsion system 105 provides the benefit of controlling both electrical power and mechanical power supplied to throttle lever 110 and a propulsor lever 115, thereby controlling the mode and/or amount of power provided, e.g., electricity from electrical power source/storage system 160 and fuel from fuel control system 150.

Thus, in general, the autothrottle controller 130 and the aircraft computer 135 are part of an avionics system of the aircraft, and the electric machine 140, turbomachine 145, and propulsor 146 are part of the propulsion system 105 of an aircraft. In various aspects of the present disclosure, the turbomachine 145 is a gas turbine engine (e.g., turboprop), which operates the turbomachine 145 by converting thermal energy from fuel combustion into mechanical energy to drive the propulsor.

In various aspects of the present disclosure, the throttle lever 110 and the propulsor lever 115 are in communication with the engine control system 120 and the autothrottle controller 130. The autothrottle controller 130 is in communication with the engine control system 120 and the aircraft computer 135.

In various aspects of the present disclosure, the engine control system 120 is in communication with the electric machine 140, the turbomachine 145 and the propulsor 146. The electric machine 140 is also in communication with the turbomachine 145 and the propulsor 146.

In various aspects of the present disclosure, the fuel control system 150 provides fuel to the turbomachine 145 and the electrical power source/storage system 160 provides electrical power/energy to the electric machine 140. As mentioned above, the electrical power source/storage system 160 can be in the form of batteries, APU, Fuel Cell, etc.

As shown in FIG. 1, the autothrottle controller 130 provides control to the engine control system 120 by receiving input from the power throttle (e.g., throttle lever 110 and propulsor lever 115), in addition to data received from the aircraft computer 135, which In various aspects of the present disclosure, can include information to aid the autothrottle controller 130 to select a thrust mode such as fuel, electrical or a hybrid fuel/electric thrust.

The engine control system 120 can include one or more processors, memory elements, and control logic configured to regulate operation of the turbomachine 145. The engine control system 120 can receive input from the autothrottle controller 130 and the throttle lever 110, and can generate control signals for fuel flow, ignition timing, and/or torque modulation. In various aspects of the present disclosure, the engine control system 120 controls the electric machine 140 and the turbomachine 145 to provide power to the propulsor 146 (e.g., to rotate the shaft of the propulsor 146 and/or to adjust the pitch of blades of the propulsor 146.

The autothrottle controller 130 can utilize a combination of propulsion system parameters to guide these control actions. For example, the controller can monitor N1 speed from the turbomachine 145 to assess current gas turbine performance, torque output from the electric machine 140 to estimate available supplemental thrust, and EGT to verify thermal operating limits are not exceeded. These parameters are processed within an internal control model to determine an energy-optimal thrust distribution between the turbomachine and electrical machine. In some aspects of the present disclosure, the controller can prioritize lower EGT operating points for emissions or engine life considerations, or use real-time torque feedback to balance electrical power demand against battery state-of-charge.

In various aspects of the present disclosure, the autothrottle controller 130 receives input from the throttle lever 110 and/or the propulsor lever 115 and determines a selected thrust level. Based on this input, along with real-time data from the aircraft computer 135 (e.g., current speed, altitude, air temperature, and/or engine health), the autothrottle controller 130 can determine how to achieve the requested thrust using one or more available power sources. For example, the autothrottle controller 130 can command the engine control system 120 to increase fuel flow to the turbomachine 145, increase output from the electric machine 140, and/or engage both systems in a coordinated manner to deliver hybrid thrust to the propulsor.

The autothrottle controller 130 dynamically balances energy efficiency, thermal constraints, and performance goals to achieve the commanded thrust in a way that reduces total energy usage across the system. In various aspects of the present disclosure, separate levers can be employed. For example, the propulsor lever 115 can command a change in propulsor pitch angle, which the autothrottle controller 130 can factor into energy optimization logic. As used herein, propulsor pitch angle refers to the angular orientation of the blades of a propulsor (e.g., propeller or fan) relative to the plane of rotation. Adjusting the pitch angle changes the aerodynamic loading of the blades, thereby affecting thrust output and efficiency at different airspeeds and engine power settings. In various aspects of the present disclosure, a single power lever is employed. For example, the controller can manage both thrust and propulsor pitch angle using an internal control model.

In response to a failure of the turbomachine or electric machine, the autothrottle controller can adjust the propulsor pitch angle to compensate for changes in available torque or to maintain aircraft performance and controllability. For example, in a single-engine-out condition in a multi-engine aircraft, the controller can reduce the pitch angle of the affected propulsor to decrease drag, while increasing pitch angle and torque from the remaining functional propulsion system to maintain symmetric thrust and directional control. In single-propulsor configurations, the pitch angle can be adjusted to improve propulsor efficiency under reduced power conditions, maximizing residual thrust from the available propulsion source.

In various aspects of the present disclosure, the aircraft computer 135 includes one or more processors, memory elements, and software modules configured to manage flight-related functions and provide data to the autothrottle controller 130. The aircraft computer 135 can monitor and/or calculate values such as altitude, air speed, ambient temperature, engine health, power source status, and/or flight phase. This information is used by the autothrottle controller 130 to determine how to allocate power among available propulsion sources.

In various aspects of the present disclosure, the electric machine 140 includes an electric machine and associated control electronics, such as an inverter or motor controller. In some aspects of the present disclosure, the electric machine 140 is coupled to the propulsor shaft directly or through a geartrain. The electric machine 140 receives electrical power from the electrical power source/storage system 160 and delivers mechanical torque to the propulsor 146 to assist or supplement the turbomachine 145.

The fuel control system 150 provides fuel to the turbomachine 145, while the electrical power source/storage system 160 provides electrical power/energy to the electric machine (e.g., motor/engine) to power the propulsor 146. The fuel control system 150 can include components such as a fuel pump, one or more flow control valves, pressure sensors, and/or embedded control circuitry. In various aspects of the present disclosure, the fuel control system 150 receives control signals from the engine control system 120 and modulates fuel delivery to the turbomachine 145 based on commanded thrust or power output. The electrical power source/storage system 160 can include one or more energy storage devices and/or generators, such as batteries, a fuel cell, an auxiliary power unit (APU), and/or a gas turbine-driven generator. In various aspects of the present disclosure, electrical power source/storage system 160 provides electrical power to the electric machine 140 and is monitored and/or managed by the aircraft computer 135 and the engine control system 120.

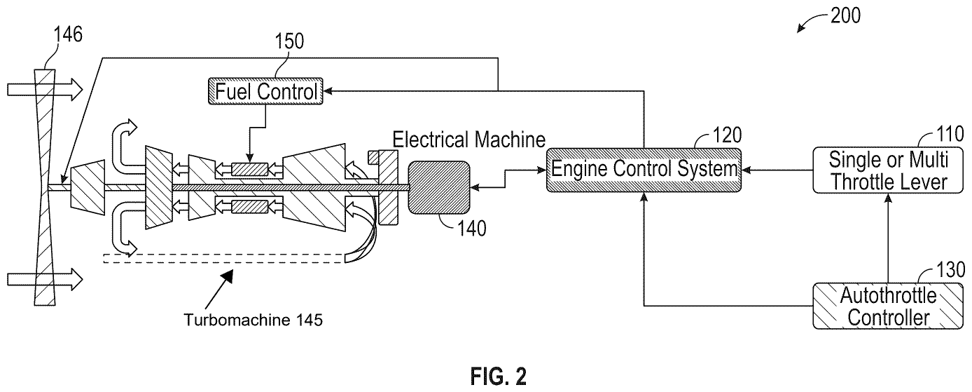

FIG. 2 is a schematic diagram of an example implementation of the autothrottle control for hybrid electric aircraft system 200 in a single engine aircraft, in accordance with an exemplary aspect. In various aspects of the present disclosure, the components shown in FIG. 2 can correspond to the components described above in FIG. 1. As shown, the system includes a throttle lever 110, which is a single or multi throttle lever used by the pilot to command overall thrust, such as thrust by fuel, electric and/or a hybrid fuel/electric energy. The throttle lever 110 is in communication with the engine control system 120 and the autothrottle controller 130. The autothrottle controller 130 receives pilot input (e.g., input from the single or multi throttle lever 110), and/or data from onboard systems (e.g., aircraft computer, environmental sensors), and determines how to achieve the requested thrust using available power sources. The engine control system 120 then modulates operation of both the fuel control system 150 and the electric machine 140 accordingly.

As shown in FIG. 2, the electric machine 140 is mechanically coupled to the shaft that drives propulsor 146, allowing it to deliver torque directly. The fuel control system 150 adjusts fuel flow to the turbomachine 145 based on commands from the engine control system 120. The engine control system 120 coordinates operation of both the electric machine 140 and the turbomachine 145 according to thrust commands generated by the autothrottle controller 130. In various aspects of the present disclosure, the autothrottle controller 130 determines the appropriate contribution from the electric machine 140 and the turbomachine 145 to achieve the commanded thrust level based on pilot input, operating conditions, and/or available energy reserves. As used herein, an “appropriate contribution” refers to a distribution of power between the electric machine 140 and the turbomachine 145 that satisfies the thrust demand while optimizing energy usage, respecting system constraints (e.g., thermal limits, battery state-of-charge), and maintaining system health. The autothrottle controller 130 makes this determination using a control model that considers current aircraft speed, altitude, flight phase, environmental conditions, propulsion system efficiency characteristics, and predictive estimates of energy consumption. The controller may prioritize electric machine output when battery reserves exceed a predefined threshold indicative of available energy sufficient to meet a commanded thrust level for a selected flight segment (e.g., cruise or descent), and when the electric machine 140 exhibits a thrust-to-energy efficiency ratio that exceeds that of the turbomachine 145 by at least a predetermined margin (e.g., 10%) under current operating conditions. In one aspect of the present disclsoure, battery reserves are considered sufficient when the state-of-charge exceeds a threshold value, such as 40% of total battery capacity, which may correspond to the minimum energy required to complete the upcoming segment of flight using electric propulsion alone. For example, during cruise flight at moderate power demand, the controller 130 can determine that electric-only propulsion satisfies the required thrust while reducing total energy consumption compared to hybrid or fuel-only modes. Alternatively, the controller 130 may prioritize turbomachine 145 output during high-thrust demands, low battery conditions, or when cooling requirements dictate reduced electric machine usage. The resulting power allocation is continuously updated based on real-time data to maintain optimal performance and energy management. The thrust-to-energy efficiency ratio is defined herein as a ratio of thrust output (e.g., in Newtons) to energy consumption (e.g., in kilojoules or equivalent units) for a given propulsion source. The autothrottle controller 130 compares these ratios for the electric machine 140 and the turbomachine 145 based on real-time or predicted inputs, such as airspeed, altitude, torque output, and battery state-of-charge, to identify the propulsion source that achieves the commanded thrust with lower total energy expenditure. The controller may use a minimum margin (e.g., 5-20%) between ratios to select one propulsion source over another based on mission-specific efficiency criteria.

In various aspects of the present disclosure, during a cruise condition at moderate altitude and power setting, the autothrottle controller 130 can determine that electric propulsion is more energy efficient than fuel-based propulsion alone, based on current battery state-of-charge, aircraft performance metrics, and system operating conditions. In such cases, the controller can identify that allocating most or all of the thrust to the electric machine 140—while reducing or suspending fuel flow to the turbomachine 145—constitutes an appropriate contribution to achieve the commanded thrust level. This determination is based on internal control models (described above), which analyze propulsion system parameters such as N1 speed, torque output, and EGT to continuously update energy-optimal thrust distribution. In such a case, the autothrottle controller 130 can command the electric machine 140 to supply most or all of the torque to the propulsor P, while reducing or suspending fuel flow via the fuel control system 150. During a high-power climb or takeoff condition, the autothrottle controller 130 can operate in a hybrid fuel-electric propulsion mode by commanding the engine control system 120 to increase fuel flow to the turbomachine 145 and also directing the electric machine 140 to contribute torque. The autothrottle controller 130 makes these determinations based on factors such as battery state-of-charge, engine efficiency characteristics, thermal operating limits, and/or mission profile.

As used herein, battery state-of-charge refers to the available electrical energy stored in the aircraft's battery system, expressed as a percentage of total capacity. When the state-of-charge is high, the controller may prioritize electric propulsion to reduce fuel consumption. Engine efficiency characteristics refer to the performance curves of the turbomachine, which may vary with throttle position, altitude, and airspeed. For example, the controller may recognize that the turbomachine operates less efficiently at low power settings, and therefore may assign a larger proportion of thrust to the electric machine under those conditions. Thermal operating limits refer to constraints on system temperature, such as the maximum allowable exhaust gas temperature (EGT) for the turbomachine or temperature limits on electric motor windings and power electronics. If these thresholds are approached, the controller may reduce power from the affected subsystem and shift thrust to the other. Finally, mission profile refers to the intended operational phase or sequence, such as takeoff, climb, cruise, loiter, descent, or emergency conditions. For example, during cruise, the system may emphasize efficiency and minimal noise, while during takeoff it may prioritize maximum available thrust from both propulsion sources.

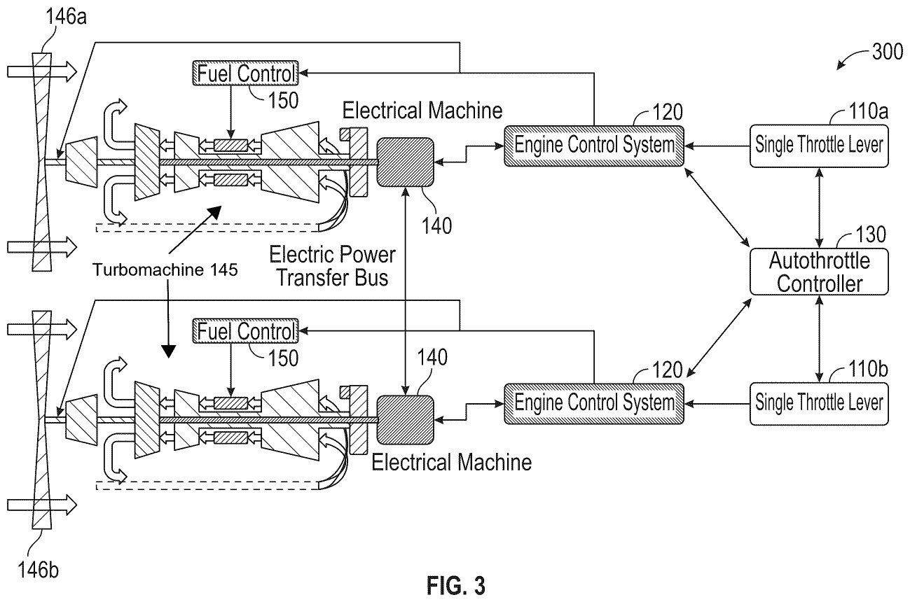

FIG. 3 is a schematic diagram of an example implementation of the autothrottle control for hybrid electric aircraft system 300 in a multiengine aircraft, in accordance with an exemplary aspect. In various aspects of the present disclosure, the components shown in FIG. 3 can correspond to the components described above in FIG. 1.

In the aspect shown in FIG. 3, the aircraft includes two independent propulsion assemblies: one associated with propulsor 146A and the other with propulsor 146B. Each propulsion assembly includes a dedicated turbomachine 145, an electric machine 140, a fuel control system 150, and a propulsor.

In various aspects of the present disclosure, a single throttle lever 110a provides input from a pilot that is communicated to the engine control system 120 and the autothrottle controller 130 to provide thrust by fuel, electric or a hybrid fuel/electric energy for propulsor 146A, while a second single throttle lever 110b provides input from a pilot that is communicated to the engine control system 120 and the autothrottle controller 130 to provide thrust by fuel, electric or a hybrid fuel/electric energy for propulsor 146B.

Throttle lever 110a and throttle lever 110b are each in communication with the engine control system 120 and the autothrottle controller 130. In various aspects of the present disclosure, either single throttle lever 110a or single throttle lever 110b is utilized to provide control for both propulsors 146A and 146B.

The engine control system 120 is responsible for coordinating fuel delivery and electrical output across both propulsion assemblies. The autothrottle controller 130 receives position data from each throttle lever and determines the required thrust for each propulsor, based on aircraft state and pilot input. As used herein, aircraft state can include one or more of the current altitude, airspeed, rate of climb or descent, attitude, power system availability, engine temperature, and environmental conditions such as ambient pressure or temperature. For example, if the aircraft is operating at high altitude with reduced air density, the controller can increase thrust commands to maintain airspeed or compensate for aerodynamic drag.

Pilot input can include the position of a single or multi-throttle lever, a requested airspeed, or a commanded climb/descent rate. The controller interprets this input to calculate a required thrust level. For instance, if the pilot advances the throttle lever to a high-power setting during takeoff, the controller can command both the turbomachine and electric machine to operate at maximum safe power levels to meet the thrust requirement. Conversely, in cruise, if the throttle lever remains steady and battery reserves are high, the controller can reduce fuel flow and rely primarily on electric power to maintain efficient forward thrust.

The autothrottle controller 130 can combine these inputs using a control algorithm that maps aircraft state variables and pilot commands to a desired thrust vector. In some aspects of the present disclosure, this control logic includes a thrust estimation model that computes the current available thrust from each power source and allocates power accordingly to meet the target. The algorithm can include performance lookup tables, multivariate regression models, or optimization routines that reduce energy usage while satisfying thrust demand and system constraints. The autothrottle controller 130 then commands the engine control system 120 to allocate thrust production between the turbomachine 145 and the electric machine 140 associated with each propulsor.

In the aspect shown in FIG. 3, the electric machine 140 associated with propulsor 146A is mechanically coupled to the same shaft as the turbomachine 145, allowing either or both to deliver torque to the propulsor. The same configuration applies to the second propulsion assembly associated with propulsor 146B. The fuel control systems 150 regulate fuel flow to their respective turbomachines 145 under the direction of the engine control system 120, which in turn receives high-level control instructions from the autothrottle controller 130.

As an example, during a takeoff condition where maximum available thrust is required, the autothrottle controller 130 commands both the turbomachines 145 and the electric machines 140 to deliver torque to their respective propulsors. During cruise flight, the autothrottle controller 130 evaluates system inputs including aircraft airspeed, altitude, battery state-of-charge, and current energy conversion efficiency of both the turbomachine 145 and electric machine 140. If the controller determines that the electric machine 140 can independently generate sufficient thrust to maintain commanded airspeed with lower energy consumption per unit of thrust compared to the turbomachine 145, the controller commands a throttle-down or shutdown state for the turbomachine 145. This decision can be further supported by operational conditions that favor electric propulsion, such as sufficient battery reserves (e.g., state-of-charge above 40% of capacity), acceptable thermal margins for the electric machine (e.g., motor temperature below a defined threshold, such as 80 degrees Celsius in one example implementation), or flight phases where reduced emissions or noise are prioritized (e.g., descent over populated areas or cruise through environmentally sensitive airspace). In such a case, the controller adjusts the electric machine 140 to maintain required torque, improving energy efficiency without compromising aircraft performance.. This type of configuration allows the aircraft to operate with improved redundancy, energy flexibility, and the potential for reduced fuel consumption depending on mission profile and available electrical reserves.

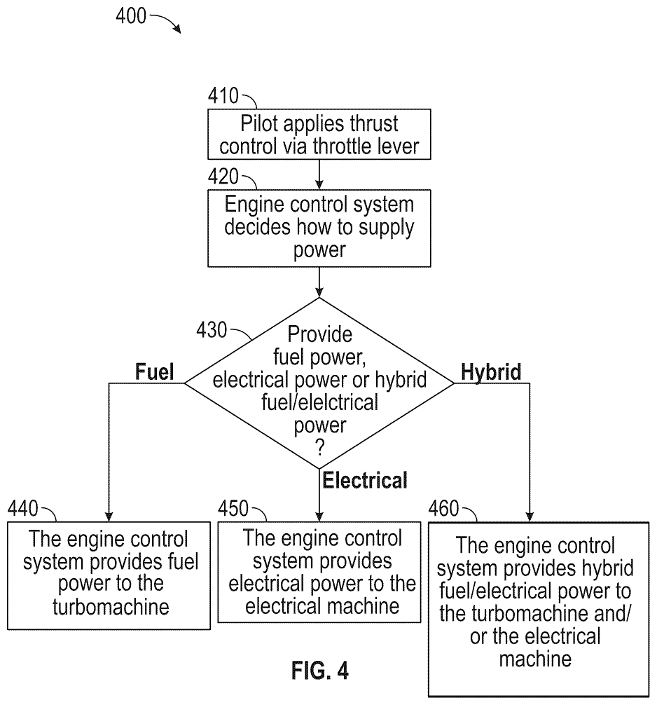

FIG. 4 is a flow diagram of an example method 400 of autothrottle control for hybrid electric aircraft system, in accordance with an exemplary aspect.

At block 410, a pilot applies thrust control via a throttle lever. As described above, In various aspects of the present disclosure, the aircraft can include either a single throttle lever 110 or a multi-throttle lever configuration.

In a single-lever arrangement, the throttle lever 110 is used by the pilot to command both engine power output and propulsor pitch. For example, the autothrottle controller 130 interprets the position of the throttle lever 110 to determine the appropriate combination of fuel flow through the fuel control system 150, electrical output from the electric machine 140, and propulsor pitch angle adjustments for the propulsor 146.

In a multi-throttle configuration, the aircraft can include separate levers that are each configured to independently control different aspects of the propulsion system. For example, multi-throttle lever configurations can include a throttle lever 110 for regulating engine power, a propulsor lever 115 for adjusting propulsor pitch angle, a mixture control lever for setting the air-fuel ratio, a condition lever for managing propulsor governor settings, and/or a dedicated electric assist lever for modulating power output from the electric machine 140 based on thrust demand or energy management objectives.

The throttle lever 110 can control the output of the turbomachine 145, while the propulsor lever 115 can directly control propulsor pitch angle. For example, during takeoff, the pilot can advance the throttle lever 110 to increase engine power and independently adjust the propulsor lever 115 to reduce propulsor pitch angle, which increases RPM for improved acceleration. During cruise, the pilot can reduce engine power via the throttle lever 110 and increase propulsor pitch angle using the propulsor lever 115 to improve efficiency.

Additional levers can be used to influence the power split between the turbomachine 145 and the electric machine 140, or to manage energy usage from the electrical power source/storage system 160. For example, the aircraft can include an electric boost lever that allows the pilot to request supplemental torque from the electric machine 140 during high-demand phases of flight, or a regenerative braking lever that enables selective charging of the power source/storage system 160 during descent or over-speed conditions.

The autothrottle controller 130 can receive inputs from one or more of these levers and, in coordination with data from the aircraft computer 135 and the engine control system 120, generate commands that allocate thrust across available power sources. Multi-throttle configurations can provide a benefit of increased control authority for the pilot or support compatibility with conventional cockpit layouts, while single-lever configurations can provide a benefit of simplified interface that reduces pilot workload and enables automated optimization of propulsion resources.

At block 420, the engine control system 120 decides how to supply propulsion power (e.g., via the turbomachine 145 and/or the electric machine 140) based on commands from the autothrottle controller 130. In various aspects of the present disclosure, the autothrottle controller (e.g., autothrottle controller 130 above) determines how to supply power based on the multiple data inputs. In various aspects of the present disclosure, data input can include input from the throttle lever 110 as well as real-time operating data relating to, for example, speed, altitude, conditions, etc., and/or due to deterioration of the propulsion system 105 (e.g., the turbomachine 145, propulsor 148, and/or electric machine 140) over time, as described above. Data can be provided to the autothrottle controller 130 from an aircraft computer (e.g., aircraft computer 135 of FIG. 1). The autothrottle controller 130 processes the inputs to evaluate current operating conditions and generate thrust commands used to determine the propulsion mode at block 430. For instance, the autothrottle controller 130 processes the inputs by executing one or more control algorithms that correlate current input values to system state classifications and performance maps. For example, inputs such as throttle lever position, airspeed, altitude, battery state-of-charge, and turbine N1 speed are provided to an internal thrust requirement model that estimates required propulsive output. In various aspects of the present disclosure, the internal thrust requirement model is a computational model implemented within the autothrottle controller 130 that estimates the amount of thrust required to maintain or achieve a commanded airspeed, climb rate, or other flight condition based on current and predicted operating parameters. The model receives as inputs one or more of throttle lever position, aircraft weight, airspeed, altitude, rate of climb or descent, battery state-of-charge, ambient conditions (e.g., temperature and pressure), and propulsion system performance metrics such as N1 speed, torque output, and exhaust gas temperature (EGT). The model may include a combination of lookup tables, physics-based equations, and predictive algorithms that account for aerodynamic drag, propulsor efficiency, and changes in aircraft performance across different flight phases. The output of the model is a target thrust value, which is then used by the autothrottle controller 130 to allocate power across the turbomachine 145 and electric machine 140 in accordance with energy optimization objectives and operational constraints. Simultaneously, subsystem efficiency models evaluate the energy cost of generating that thrust using the turbomachine 145 versus the electric machine 140, under current environmental and system conditions. Based on these calculations, the controller classifies the current operating condition (e.g., cruise, climb, descent) and determines an optimal propulsion mode—electric-only, fuel-only, or hybrid—to satisfy the thrust demand while minimizing energy consumption or satisfying mission-specific constraints (e.g., reduced emissions or thermal load).

Accordingly, based upon the inputs and operating parameters evaluated at block 420, at block 430, is the autothrottle controller 130 determines whether to provide propulsion using fuel power, electrical power, or a hybrid fuel/electrical power. The autothrottle controller 130 can consider factors such as throttle lever position, altitude, air speed, engine temperature, battery state-of-charge, and overall power demand. An internal control algorithm can compare these parameters to system constraints, energy availability, and efficiency targets. For example, if electrical energy is sufficient and the aircraft is in cruise, the autothrottle controller 130 can prioritize electric propulsion. In a high-power climb or when battery reserves are low, the autothrottle controller 130 can rely on fuel-based or hybrid propulsion. In various aspects of the present disclosure, considerations can include engine wear, thermal limits, and flight phase.

Based on the determinations at block 420, if at block 430 the autothrottle controller 130 selects fuel-based propulsion, at block 440, the engine control system 120 commands the fuel control system 150 to supply fuel power to the turbomachine 145. The turbomachine 145 can generate mechanical power to drive the propulsor 146 directly. For example, during a takeoff phase or initial climb, when maximum sustained thrust is needed and the electrical energy reserves are being conserved, the autothrottle controller 130 can prioritize fuel power to ensure continuous and high-output operation from the turbomachine 145.

Based on the determinations at block 420, if at block 430 is the autothrottle controller 130 selects electrical propulsion, at block 450, the engine control system 120 coordinates with the electrical power source/storage system 160 to deliver electrical power to the electric machine 140. In various aspects of the present disclosure, the electric machine 140 can drive the propulsor 146 without input from the turbomachine 145. For example, during a descent or low-power phase when thrust demands are minimal and/or fuel economy or emission reduction is prioritized, the autothrottle controller 130 can disable fuel delivery and rely solely on the electric machine 140 to provide propulsor torque.

Based on the determinations at block 420, if at block 430 is the autothrottle controller 130 selects to provide hybrid power, at block 460, the engine control system 120 provides hybrid fuel/electrical power from both the turbomachine 145 and the electric machine 140. The turbomachine 145 can be controlled via the fuel control system 150 while the electric machine 140 receives electrical energy from the electrical power source/storage system 160. For example, during a climb at high altitude when maximum thrust and system redundancy are targeted, the autothrottle controller 130 can engage both the turbomachine 145 and the electric machine 140 to deliver combined torque to the propulsor 146. If a failure is detected, the autothrottle controller 130 may select a hybrid or degraded power mode and adjust the propulsor pitch angle in conjunction with power reallocation to preserve flight performance or manage asymmetric thrust effects.

As used herein, a “power mode” refers to an operational configuration of the propulsion system that determines which energy sources are used to generate thrust. The autothrottle controller 130 selects a power mode based on throttle inputs, real-time operating data, system health, and mission objectives.

In various aspects, the autothrottle system supports multiple power modes, including fuel-only power mode, electric-only mode, hybrid power mode, and/or degraded power mode. In fuel-only power mode thrust is provided solely by the turbomachine. This mode may be preferred during high-demand phases such as takeoff or when battery reserves are insufficient. In electric-only power mode, thrust is provided solely by the electric machine. This mode may be selected during cruise to conserve fuel or reduce acoustic and emission signatures, provided sufficient battery charge is available. In hybrid power mode, both the turbomachine 145 and electric machine 140 contribute torque to the propulsor 146. This allows blending power sources to meet thrust demands while balancing fuel consumption, thermal limits, and battery charge. The degraded power mode refers to fallback operation when one power source is partially or fully unavailable. For example, in the event of a turbomachine 145 failure, the controller 130 can enter a degraded electric-only power mode to maintain reduced thrust. Similarly, in the event of battery depletion or electric machine 140 thermal limits, the controller 130 can reduce or eliminate electric contribution and rely on fuel-only operation.

The selected power mode directly affects how the controller 130 allocates fuel flow, electrical output, and propulsor pitch settings. In hybrid mode, the controller 130 dynamically distributes torque based on propulsion efficiency models and current flight conditions. In degraded mode, thrust delivery is prioritized for flight safety and controllability, even if energy efficiency is reduced.

Transitions between power modes can occur during flight in response to changing conditions. The autothrottle controller continuously evaluates propulsion system parameters (e.g., torque, N1 speed, EGT), energy availability (e.g., battery state-of-charge), and environmental factors (e.g., altitude, temperature) to determine the appropriate power mode for each phase of flight. This adaptive control strategy enables robust, energy-aware, and fault-tolerant operation in hybrid electric turboprop aircraft.

Although various blocks of the method 400 are shown in an order, it should be noted that not all blocks are implemented in any order and can be applied in any sequence to the blocks of method 400.

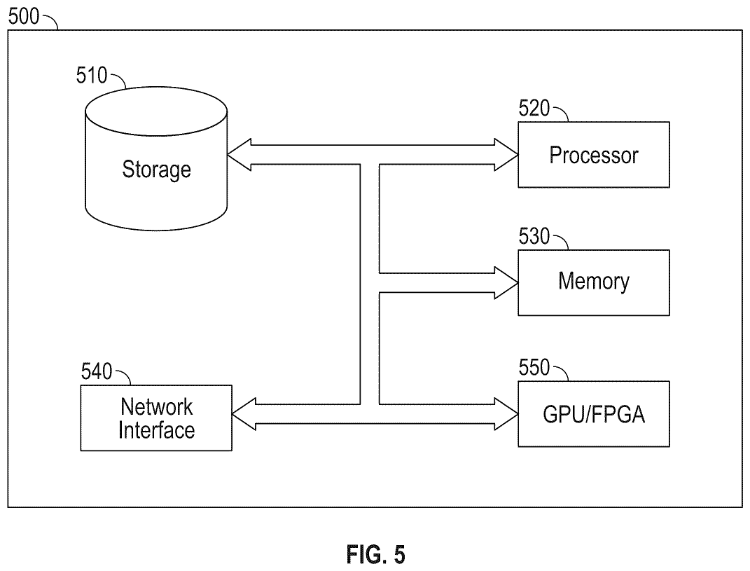

FIG. 5 is a block diagram of a computing device 500 of the system of FIG. 1, in accordance with one aspect. In various aspects of the present disclosure, computing device 500 is implemented in the engine control system 120 and/or the autothrottle controller 130 of FIG. 1. Referring now to FIG. 5, exemplary components in the computing device 500 in accordance with aspects of the present disclosure include, for example, a database 510, one or more processors 520, at least one memory 530, and a network interface 540. In aspects, the computing device 500 can include a graphical processing unit (GPU) 550, which can be used for processing machine learning network models. Various components of computing device 500 are utilized to carry out instructions to perform the operations described in blocks 410-460 of FIG. 4.

Database 510 can be located in storage. The term “storage” can refer to any device or material from which information is capable of being accessed, reproduced, and/or held in an electromagnetic or optical form for access by a computer processor. Storage can be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In some aspects of the present disclosure, data can be stored on computing device 500, including, for example, user preferences, historical data, and/or other data. The data can be stored in database 510 and sent via the system bus to processor 520.

As described above, processor 520 can execute various processes based on instructions that can be stored in the server memory 530 and utilizing the data from database 510. The illustration of FIG. 5 is exemplary, and persons skilled in the art will be understood by other components that can exist in the computing device 500. Such other components are not illustrated in FIG. 5 for clarity of illustration.

Accordingly, described above in various aspects is a single throttle lever system for a hybrid electric aircraft that optimizes the energy usage for a given throttle position and aircraft operating environment by setting the thrust demand from the turbomachine 145 and electric propulsion motors of electric machine 140 to reduce total energy usage from two or more different energy sources.

In various aspects of the present disclosure, hydrocarbon fuel usage can be reduced based on flight plan and electrical energy available, where the turbomachine 145 is a turboprop engine or a turbofan engine.

In some aspects of the present disclosure, various energy sources can include a combustion fuel for turbomachine 145, fuel for a fuel cell to produce electricity for electric machine 140, and/or batteries.

In certain aspects, the autothrottle system can also include a propulsor or fan pitch setting, and an efficiency model of each thrust producer.

In various aspects of the present disclosure, each efficiency model is a multivariate table and inputs to each efficiency model can include throttle position, ambient pressure/altitude, air speed of the aircraft, and can output a thrust to energy ratio for the given device or other similar output.

In some aspects of the present disclosure, the autothrottle system and efficiency models can include minimum settings for the turbomachine 145 or electric machines of electric machine 140 to provide the required air flow and pressure to a cabin environment system, minimum settings for the turbomachine 145 or electric machines of electric machine 140 to provide the required hydraulic system power for the aircraft, and/or minimum/maximum settings for the turbomachine 145 or electric machines of electric machine 140 to provide the required electrical power to the aircraft, taking into account all loads on the available electrical power sources.

The disclosed system provides enhanced control, energy optimization, and resilience for hybrid electric turboprop aircraft. It enables dynamic allocation of power sources, integrates seamlessly with modern cockpit controls, and supports safe operation under a variety of mission conditions and fault scenarios.

Accordingly, the present disclosure provides an autothrottle control system for hybrid electric turboprop aircraft that dynamically allocates fuel-based and electric propulsion resources based on throttle input, propulsion system data, and aircraft operating conditions. The system uses targeted power allocations derived from real-time analyses to improve energy efficiency, maintain thrust, and support safe operation across varying mission profiles.

Conventional autothrottle systems do not support real-time thrust coordination across hybrid propulsion sources. These systems are typically limited to controlling a single fuel-based engine and do not consider the dynamic interplay between electric power availability, battery state-of-charge, engine thermal constraints, and energy optimization objectives. The present system addresses these deficiencies by providing a unified autothrottle controller capable of evaluating operational conditions, determining a propulsion power mode, and allocating fuel-based and electric power in a way that optimizes performance, reduces energy consumption, and maintains safe aircraft operation, even under failure or degraded conditions.

Further aspects of the present disclosure are provided by the subject matter of the following paragraphs.

An autothrottle control system includes a throttle lever; a propulsion system including a turbomachine, an electric machine, and a propulsor including one or more blades; and an autothrottle controller operatively coupled with the throttle lever and the propulsion system. The autothrottle controller is configured to: detect a first input from the propulsion system, the first input including at least one of a thrust measurement or a speed measurement; detect a second input from the throttle lever, the second input including at least one of a selected thrust or a selected speed; perform an analysis, based on the first input and the second input, to determine a power mode for propelling an aircraft, wherein the analysis includes evaluating current aircraft operating conditions and comparing a measured speed or thrust with a selected speed or thrust to determine a targeted allocation of fuel-based and electric propulsion resources that satisfies the selected thrust and reduces total energy usage; and selectively control one or more operational parameters of the propulsion system, including a fuel flow to the turbomachine, an electrical power output of the electric machine, and a propulsor pitch angle, to provide at least one of mechanical or electrical power to the propulsor in accordance with the determined power mode.

The system according to any preceding clause, wherein the autothrottle controller receives the at least one speed measurement or thrust measurement from at least one of the turbomachine or the electric machine.

The system according to any preceding clause, wherein the autothrottle controller receives the at least one speed measurement or thrust measurement from the propulsor.

The system according to any preceding clause, further comprising: receiving a third input from an aircraft computer, the third input including at least one of an altitude, an ambient temperature, an engine health, a flight phase, or a power source status of the propulsion system.

The system according to any preceding clause, wherein the throttle lever includes a first lever configured to selectively control the turbomachine and a second lever configured to selectively control the propulsor.

The system according to any preceding clause, wherein the throttle lever is a single lever that controls both the turbomachine and the propulsor.

The system according to any preceding clause, wherein the autothrottle controller is configured to adjust one or more control parameters of the propulsion system, including at least one of the fuel flow, the electrical power output, or the propulsor pitch angle, to optimize energy usage in response to aircraft operating conditions.

The system according to any preceding clause, wherein the autothrottle controller is configured to adjust said control parameters to enhance emissions performance, contrail mitigation, fuel efficiency, or thermal regulation.

The system according to any preceding clause, wherein the autothrottle controller is configured to reallocate propulsion power by adjusting control parameters in response to a failure of the turbomachine or the electric machine.

The system according to any preceding clause, wherein the autothrottle controller is further configured to adjust the propulsor pitch angle based on the failure.

The system according to any preceding clause, wherein the autothrottle controller is configured to adjust thrust using one or more control parameters to maintain a constant airspeed.

The system according to any preceding clause, wherein the turbomachine includes a first turbomachine and a second turbomachine; the electric machine includes a first electric machine and a second electric machine; the propulsor includes a first propulsor operatively associated with the first turbomachine and the first electric machine, and a second propulsor operatively associated with the second turbomachine and the second electric machine; and the autothrottle controller is configured to independently or jointly control the first and second propulsion assemblies by adjusting one or more control parameters to meet thrust demands.

A processor-implemented method for an autothrottle control system includes: detecting a first input from a propulsion system, the first input including at least one of a thrust measurement or a speed measurement; detecting a second input from a throttle lever, the second input including at least one of a selected thrust or a selected speed; performing an analysis based on the first input and the second input to determine a power mode for providing propulsion to a propulsor, the analysis including evaluating current aircraft operating conditions and comparing the detected measurement with the selected thrust or speed to determine a targeted allocation of fuel-based and electric propulsion resources that satisfies the selected thrust requirement and reduces overall energy usage; and selectively adjusting one or more control parameters of the propulsion system, including at least one of a fuel flow, an electrical power output, or a propulsor pitch angle, to provide at least one of mechanical or electrical power to the propulsor in accordance with the determined power mode.

The processor implemented method according to any preceding clause, wherein detecting the first input includes receiving a speed or thrust measurement from at least one of a turbomachine or an electric machine.

The processor implemented method according to any preceding clause, wherein the throttle lever comprises a first lever for controlling output from a turbomachine and a second lever for controlling the propulsor pitch angle, or a single lever that controls both the turbomachine and the propulsor pitch angle.

The processor implemented method according to any preceding clause, wherein adjusting the one or more control parameters includes optimizing energy usage based on operational conditions, and wherein optimization is performed to enhance at least one of emissions performance, contrail avoidance, fuel efficiency, or thermal regulation.

The processor implemented method according to any preceding clause, further comprising adjusting control parameters in response to a failure of a turbomachine or an electric machine to reallocate propulsion power and maintain thrust.

The processor implemented method according to any preceding clause, further comprising dynamically adjusting said control parameters based on one or more of aircraft speed, altitude, environmental conditions, or system health.

The processor implemented method according to any preceding clause, wherein adjusting the control parameters includes controlling the propulsor pitch angle.

The processor implemented method according to any preceding clause, wherein: a turbomachine includes a first turbomachine and a second turbomachine; an electric machine includes a first electric machine and a second electric machine; the propulsor includes a first propulsor associated with the first turbomachine and the first electric machine, and a second propulsor associated with the second turbomachine and the second electric machine; and the autothrottle controller adjusts control parameters to independently or jointly control the first and second propulsion assemblies.

The processor implemented method according to any preceding clause, wherein determining the power mode includes analyzing propulsion system performance metrics comprising speed, torque, or thermal output data.

The processor implemented method according to any preceding clause, wherein evaluating current aircraft operating conditions comprises determining at least one of aircraft speed, altitude, ambient temperature, engine efficiency, battery state-of-charge, or mission profile characteristics.

The processor implemented method according to any preceding clause, wherein the targeted allocation comprises selecting a percentage contribution from the turbomachine and the electric machine based on thrust demand and available energy reserves.

Those skilled in the relevant art(s) will appreciate that various adaptations and modifications of the aspects described above can be configured without departing from the scope and spirit of the disclosure. Therefore, it is to be understood that, within the scope of the appended claims, the teachings featured herein can be practiced other than as specifically described herein.

What is claimed is:

1. An autothrottle control system, comprising:
a throttle lever;
a propulsion system, including:
a turbomachine;
an electric machine; and
a propulsor including one or more blades; and an autothrottle controller operatively coupled with the throttle lever and the propulsion system, the autothrottle controller configured to:
detect a first input from the propulsion system, the first input including at least one of a thrust measurement or a speed measurement;
detect a second input from the throttle lever, the second input including at least one of a selected thrust or a selected speed;
perform an analysis, based on the first input and the second input, to determine a power mode for propelling an aircraft, wherein the analysis includes evaluating current aircraft operating conditions and comparing a measured speed or thrust with a selected speed or thrust to determine a targeted allocation of fuel-based and electric propulsion resources that satisfies the selected thrust and reduces total energy usage; and
selectively control one or more operational parameters of the propulsion system, including a fuel flow to the turbomachine, an electrical power output of the electric machine, and a propulsor pitch angle, to provide at least one of mechanical or electrical power to the propulsor in accordance with the determined power mode.

2. The autothrottle control system of claim 1, wherein the autothrottle controller receives the at least one speed measurement or thrust measurement from at least one of the turbomachine or the electric machine.

3. The autothrottle control system of claim 1, wherein the autothrottle controller receives the at least one speed measurement or thrust measurement from the propulsor.

4. The autothrottle control system of claim 1, further comprising:
receiving a third input from an aircraft computer, the third input including at least one of an altitude, an ambient temperature, an engine health, a flight phase, or a power source status of the propulsion system.

5. The autothrottle control system of claim 1, wherein the throttle lever includes a first lever configured to selectively control the turbomachine and a second lever configured to selectively control the propulsor.

6. The autothrottle control system of claim 1, wherein the throttle lever is a single lever that controls both the turbomachine and the propulsor.

7. The autothrottle control system of claim 1, wherein the autothrottle controller is configured to adjust one or more control parameters of the propulsion system, including at least one of the fuel flow, the electrical power output, or the propulsor pitch angle, to optimize energy usage in response to aircraft operating conditions.

8. The autothrottle control system of claim 7, wherein the autothrottle controller is configured to adjust said control parameters to enhance emissions performance, contrail mitigation, fuel efficiency, or thermal regulation.

9. The autothrottle control system of claim 1, wherein the autothrottle controller is configured to reallocate propulsion power by adjusting control parameters in response to a failure of the turbomachine or the electric machine.

10. The autothrottle control system of claim 9, wherein the autothrottle controller is further configured to adjust the propulsor pitch angle based on the failure.

11. The autothrottle control system of claim 1, wherein the autothrottle controller is configured to adjust thrust using one or more control parameters to maintain a constant airspeed.

12. The autothrottle control system of claim 1, wherein the autothrottle controller determines the power mode based at least in part on one or more propulsion system parameters indicative of propulsion system performance including N1 speed, torque output, or exhaust gas temperature (EGT).

13. The autothrottle control system of claim 1, wherein the turbomachine includes a first turbomachine and a second turbomachine;
the electric machine includes a first electric machine and a second electric machine;
the propulsor includes a first propulsor operatively associated with the first turbomachine and the first electric machine, and a second propulsor operatively associated with the second turbomachine and the second electric machine; and
the autothrottle controller is configured to independently or jointly control the first and second propulsion assemblies by adjusting one or more control parameters to meet thrust demands.

14. A processor-implemented method for an autothrottle control system, the method comprising:
detecting a first input from a propulsion system, the first input including at least one of a thrust measurement or a speed measurement;
detecting a second input from a throttle lever, the second input including at least one of a selected thrust or a selected speed;
performing an analysis based on the first input and the second input to determine a power mode for providing propulsion to a propulsor, the analysis including evaluating current aircraft operating conditions and comparing the detected measurement with the selected thrust or speed to determine a targeted allocation of fuel-based and electric propulsion resources that satisfies the selected thrust requirement and reduces overall energy usage; and
selectively adjusting one or more control parameters of the propulsion system, including at least one of a fuel flow, an electrical power output, or a propulsor pitch angle, to provide at least one of mechanical or electrical power to the propulsor in accordance with the determined power mode.

15. The processor-implemented method of claim 14, wherein detecting the first input includes receiving a speed or thrust measurement from at least one of a turbomachine or an electric machine.

16. The processor-implemented method of claim 14, wherein the throttle lever comprises a first lever for controlling output from a turbomachine and a second lever for controlling the propulsor pitch angle, or a single lever that controls both a turbomachine and a propulsor pitch angle.

17. The processor-implemented method of claim 14, wherein adjusting the one or more control parameters includes optimizing energy usage based on operational conditions, and wherein optimization is performed to enhance at least one of emissions performance, contrail avoidance, fuel efficiency, or thermal regulation.

18. The processor-implemented method of claim 14, further comprising adjusting control parameters in response to a failure of a turbomachine or an electric machine to reallocate propulsion power and maintain thrust.

19. The processor-implemented method of claim 18, further comprising dynamically adjusting said control parameters based on one or more of aircraft speed, altitude, environmental conditions, or system health.

20. The processor-implemented method of claim 14, wherein adjusting the control parameters includes controlling the propulsor pitch angle.
